(19) United States
(12) Patent Application Publication
(10) Pub. No.: US 2025/0346799 A1
(43) Pub. Date: Nov. 13, 2025

(54) MATERIAL AND METHODS FOR ENHANCED TRIAZINE-H2S SCAVENGING EFFICIENCY IN BUBBLE TOWER REACTOR USING NANO-BUBBLING TECHNOLOGY

(71) Applicant: Halliburton Energy Services, Inc., Houston, TX (US)

(72) Inventors: Zhiwei Yue, Sugar Land, TX (US); Chunli Li, The Woodlands, TX (US); Ronald Bosch, Houston, TX (US)

(21) Appl. No.: 18/659,533

(22) Filed: May 9, 2024

(51) Int. Cl. C09K 8/532

(52) U.S. Cl. CPC C09K 8/532; C09K 2208/10; C09K 2208/20

(57) ABSTRACT

Described herein are methods and materials for increasing the scavenging efficiency of hydrogen sulfide collected or produced in subterranean formations during wellbore environments. The methods can include first identifying a location that may include a concentration of gas that may contain high concentrations of H₂S gas. The gas may be initially collected and tested to determine the concentration of gas within the gas mixtures. The gas mixture, after testing, may then be passed through a bubble tower reactor that includes a concentration of scavenging material to scavenge H₂S gas from the gas mixture and produce a cleaner gas after treatment.

### TECHNICAL FIELD

The present disclosure relates generally to wellbore operations and, more particularly (although not necessarily exclusively), to materials and methods for improving sour gas scavenging efficiency for use in wellbore or production operations.

### BACKGROUND

The term sour gas is synonymously known as natural gas that contains a measurable amount of hydrogen sulfide (H₂S). Sour gas released during wellbore or hydrocarbon operations of subterranean formations may be corrosive and may cause damage to wellbore equipment as well and may pose health and safety concerns. Thus, methods for treating sour gas can be employed in oil field and hydrocarbon production operations, including but not limited to, during drilling operations. One method involves the use of bubble tower reactors however, current methods employing these towers may not be cost effective, may be time consuming, removal of material may be inefficient, and the systems, when operated incorrectly, can lead to the production of foam in the system, which may cause inadequate scavenging.

### BRIEF DESCRIPTION OF THE DRAWINGS

FIG. 1 is a cross sectional view of a well system for drilling and collecting hydrocarbons from the subterranean formation whereby sour gas in the subterranean formation may be released and collected according to one example of the present disclosure.

FIG. 2 is a block diagram of a method for treating sour gas released from a subterranean formation according to one example of the present disclosure.

FIG. 3 is an example diagram of a bubble tower reactor configured for treating gas released and collected from subterranean formations according to one example of the present disclosure.

FIG. 4 is an example schematic of the bubbles produced in a bubble tower reactor according to one example of the present disclosure.

### DETAILED DESCRIPTION

Certain aspects and examples of the present disclosure involve materials and methods for improving the efficiency of H₂S scavenging using nano-bubblers in bubble tower reactors. Subterranean formations commonly produce and contain gases. For example, H₂S may be produced from multiple sources and can be entrapped or contained in subterranean formations. In a first scenario, H₂S can be produced by sulphate-reducing bacteria in formation water at formation conditions to reduce sulphate to H₂S. In a second scenario, H₂S gas may be produced in a process known as aquathermolysis. The process entails injecting steam into a reservoir at high temperature and pressure causing a thermochemical production of H₂S, CH₄, CO₂, CO, and H₂ from organosulfur species or metal sulfides. In a third scenario, H₂S may be produced via thermochemical sulfate reduction (TSR). TSR is a process wherein sulfate minerals and oxidation of hydrocarbons occurs at temperatures above 100° C. in the formation.

Over time, the concentration of H₂S may increase as more sulfate minerals are reduced. Gas released from subterranean formations during wellbore operations or produced as byproducts from reactions may be a mixture of multiple types of gas. For example, the gas mixture may include CO, CO₂, CH₄, and H₂ gas. In the event the gas has measurable amounts of H₂S, it is commonly referred to as sour gas. Sour gas may refer to a gas that has at least four (4) ppm of H₂S in the gas mixture. Methods for removing H₂S from gas may utilize triazine or other scavenging materials. For example, triazine is a nitrogen containing heterocyclic compound, in the presence of H₂S, a first substitution occurs to produce dithiazine followed by further substitutions until triathine is produced. Other sources of produced H₂S can include the bacterial decomposition of human and animal wase presenting as an emission from sewage treatment facilities and landfills, petrochemical plants, coke oven plants, and kraft paper mills.

Removal of H₂S gas from the gas byproducts of the above-mentioned methods may be of interest for environmental reasons. For example, during well drilling and hydrocarbon production operations H₂S gas collected and produced from the formation may have high concentrations of H₂S resulting in the classification of sour gas. The sour gas must be treated to remove H₂S from the gas and create a cleaner gas mixture or in other terms make the gas sweet (for example, reduce the H₂S to below 4 ppm). In some embodiments, H₂S gas may be scavenged from the gaseous mixture using bubble tower reactors.

In commonly used bubble tower reactors, the efficiency of removal may be impacted by the surface area of the bubbles, the concentration of the solution, and bubble path time (contact time). For example, in environments where the bubbles are heterogenous, the differences in size distribution of the gas bubbles may lead to inefficient removal of harmful gas from the gas mixture. Additionally, the larger the bubble, the faster they rise through the solution thereby decreasing contact time with the scavenging material. In an alternate scenario, the concentration of scavenging material within the solution may need to be increased to account for the non-uniformity of the bubbles. The increase of the scavenging material, for example triazine, may be harmful to the environment.

In contrast, embodiments of the present disclosure can increase efficiency of scavenging and allow for systematic alterations to the scavenging methods to alter the scavenging process when applied to different environments. For example, the amount, size, pressure, and gas content of bubbles produced within the tower can be controlled to adjust scavenging. Additionally, the solution used for scavenging can be controlled such that the concentration of triazine or other scavenging chemical used can be changed allowing for controlling of chemical moieties. This can allow for a more efficient, cost effective, and cleaner removal of various gases within the gas mixture. Embodiments of the present disclosure can also be used to remove other gases in addition to H₂S from gas released or produced during drilling and production operations by changing the scavenging material and the input gas passed through the solution. In some embodiments, the reactors or capturing facility may be reduced in size as compared to common methods for capturing H₂S while simultaneously maintaining the same capturing capability of H₂S. The reduced size may translate to a lower capital cost.

In a particular example, the methods disclosed herein may include using a nano-bubbler for the sparger in a contact tower. The use of a nano-bubbler may increase surface area of the gas bubbles in the solution because the generated nano-bubbles has a large surface area when compared to their volume. The use of the nano-bubbler may increase contact time and surface area of the gas inside of the tower. In some embodiments, the methods described herein may be employed on alternate less H₂S-rich gas streams.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

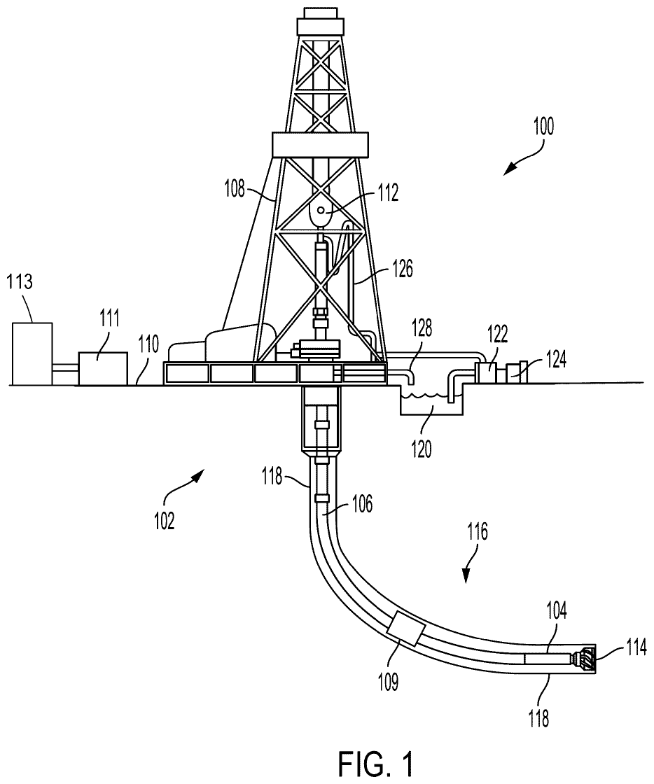

FIG. 1 is a cross sectional view of a well system for drilling, releasing, and collecting hydrocarbons from the subterranean formation whereby sour gas in subterranean formations may be released and collected according to one example of the present disclosure. A wellbore 118 used to extract hydrocarbons may be created by drilling into a subterranean formation 102. The well system 100 may include a bottom hole assembly (BHA) 104 positioned or otherwise arranged at the bottom of a drill string 106 extended into the subterranean formation 102 from a derrick 108 arranged at the surface 110. The derrick 108 includes a kelly 112 used to lower and raise the drill string 106. The BHA 104 may include a drill bit 114 operatively coupled to a tool string 116, which may be moved axially within the drilled wellbore 118 as attached to the drill string 106. The combination of any support structure (in this example, derrick 108), any motors, electrical equipment, and support for the drill string 106 and tool string 116 may be referred to herein as a drilling arrangement.

During operation, the drill bit 114 can penetrate the subterranean formation 102 to create the wellbore 118 where sour gas may be located. The BHA 104 can provide control of the drill bit 114 as the drill bit 115 advances into the subterranean formation 102. The combination of the BHA 104 and drill bit 114 can be referred to as the drilling tool. Fluid or “drilling mud” from a mud tank 120 may be pumped downhole using a mud pump 122 powered by an adjacent power source, such as a prime mover or motor 124. Alternatively, assemblies may be in place for pumping gas out of the subterranean formation through pipes and lines into storage tanks or holding tanks to be processed. In some embodiments, systems may be in place for pumping steam down a formation to stimulate a formation for hydrocarbon production. During such process H₂S gas may be generated as described above. In such scenarios, gas generated, or collected during operations may be pumped to the surface and further routed to alternate locations for scavenging the H₂S from the gas.

In some embodiments, the operation site includes a bubble tower reactor 111 and system 113 for collecting the gas from the operations. For example, through pipes and systems attached to the derrick 108, such as pipes running parallel or in combination with the pipes 126 for pumping mud downhole. The flow lines may be in fluid and gas communication with the bubble tower reactor. In some embodiments, the flow lines for gas collection may be in fluid connection with storage tanks for holding the gas. The gas may be subsequently stored in gas cylinders for collecting the gas and may be used in the bubble tower reactor 111 and the systems 113 for collecting the gas from the wellbore or hydrocarbon production operations. The system 113 for collecting the gas from the wellbore or hydrocarbon production operations may include a fluid containment at least partially filled with a liquid for scavenging H₂S. The system 113 may further include one or more sensors for monitoring a first characteristic of the liquid or the gaseous mixture and one or more controllers for controlling a second characteristic of the liquid or the gaseous mixture. The characteristics of the liquid or gaseous mixture may include one or more of a temperature, a pressure, a flow rate, a concentration of a salt, a concentration of H₂S, a concentration of the H₂S scavenging material, a concentration of a contaminant, or a concentration of the reaction product for reaction between H₂S and the H₂S scavenging material. One skilled in the art may understand that the methods disclosed herein, while used in examples for well drilling, may be employed for use in any operation and method wherein sour gas is collected or produced, such as during a hydrocarbon production process.

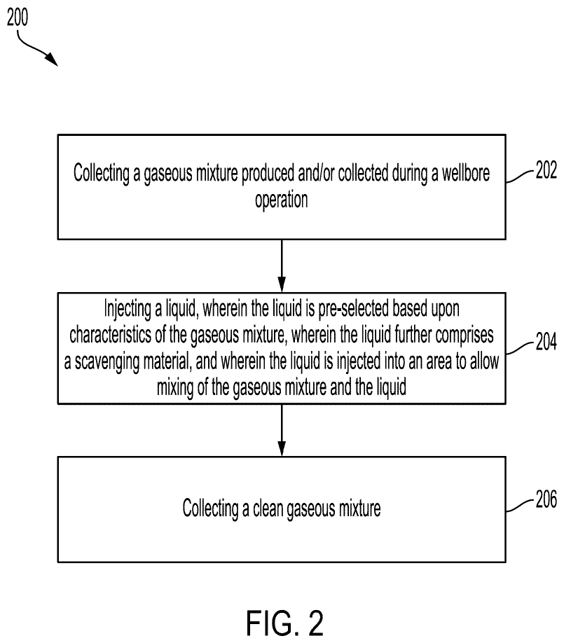

FIG. 2 is a block diagram of a process 200 for treating sour gas released from a subterranean formation according to one example of the present disclosure. At block 202, the gas mixture produced by or isolated within the subterranean formation is collected. The collection process may utilize pipes or tubing disposed within the wellbore and connected to surface equipment. The surface equipment may include holding tanks that may store the gaseous mixture. In some embodiments, the gaseous mixture may be disposed into cylinders and transported off site for treatment. In an alternate embodiment, the gas cylinders containing the sour gas may be treated on site in bubble tower reactors. Alternative methods for treating the sour gas may be employed. For example, the sour gas may be treated by direct injection using an L-DAC system as described above. In certain embodiments, the scavenging may occur via use of a nanobubble generating sparger. For example, the gaseous mixture may be injected into a liquid as a plurality of nanobubbles. In some embodiments, the gaseous mixture may be injected at a flow rate of from 1 to 5000 gallons per minute into the liquid. This liquid may comprise a H₂S scavenging material that interacts with the nanobubbles to remove H₂S from the nanobubbles.

At block 204, a bubble tower system, as described further below, is filled with a liquid. The liquid may include a concentration of a scavenging material. In some embodiments, the concentration of the scavenging material is determined based upon the concentration of H₂S gas in the gaseous mixture. For example, the higher the concentration of H₂S in the gas, the higher the concentration of scavenging material may be dissolved in the liquid. In some embodiments, the concentration of H₂S scavenging material may be from 1 ppm to 10000 ppm. In some embodiments, the liquid may be a water or a brine. In embodiments including brine, the salinity of the brine may be controlled. For example, the salinity of the brine may be from 1 part per thousand (ppt) to 50 ppt. In some embodiments, the temperature of the liquid inside the bubble tower reactor may also be controlled. For example, the temperature may be maintained at a temperature range from 50° F. up to 300° F., or from 50° F. to 100° F., from 100° F. to 150° F., from 150° F. to 200° F., from 200° F. to 250° F., or from 250° F. to 300° F. In some embodiments, gas within the gas mixture may also be controlled.

In some embodiments, gas within the gas mixture may also be controlled for improving the efficiency of scavenging. For example, the carrier gas and other gasses may be injected into the gas mixture or removed from the gas mixture before the gas in passed through the bubble tower reactor. In some embodiments, the system may comprise a injection port for injecting a carrier gas or a scavenging material to remove unwanted gasses before it is injected into the bubble tower reactor. In some embodiments, where the CO₂ gas is present within the gas mixture the efficiency of scavenging may be decreased. In such embodiments, the CO₂ gas within the gas mixture may be controlled for improving the efficiency of scavenging. For example, the CO₂ gas concentration in the gas mixture may be first reduced before the gas mixture enters the bubble tower reactor. In some embodiments, decreasing the concentration of CO₂ in the gas mixture before the gas passes through the nano-bubbler may increase the efficiency of removal of H₂S from the gas mixture. For example, the CO₂ concentration may be reduced in the gas mixture by at least 5% by volume, by at least 10% by volume, by at least 15%, by at least 20%, or by at least 25% by volume.

The injection into the bubble tower reactor may be in a continuous flow or may be performed in a batch operation. During a batch operation, the liquid is injected into the bubble tower reactor until at least 75% of the tower is filled with liquid, for example. The gas mixture is injected into the tower at a constant rate until the liquid is spent of the scavenging material. For example, when at least 80% by volume of the scavenging material has been converted, the injection of gas is shut off and the solution from the tank is released through pipelines and into a holding tank. The tower may then be refilled with a new batch of liquid and the process may be repeated. The process may be repeated until the gas collected from the subterranean formation has all been passed through a bubble tower reactor to remove at least 70% of the H₂S gas. For example, the gas is treated in the bubble tower reactor until at least 70% H₂S is removed, at least 75% H₂S is removed, at least 80% H₂S is removed, at least 85% H₂S gas is removed, or at least 90% H₂S gas is removed. In a continuous flow system, the liquid containing the scavenging material is injected via droplet spray injection, into the pipeline or flowline containing the sour gas mixture.

At block 206, the gas, following treatment, may be collected. For example, the gas, after passing through the system may be diverted, via pipelines, to a storage containers. In some embodiments, the storage containers may be cylinders. The gas collected may be tested by using an H₂S analyzer, absorption spectroscopy, electrochemical sensor cell, colorimetric methods, or gas chromatography methods. For example, the gas may be tested to determine the concentration of H₂S. For example, if the concentration is sufficiently low, scavenging may be considered completed and/or the gas may be considered safe. If the concentration is high, the gas may be treated a second time or repeated until the concentration of H₂S is at or below a threshold limit, such as 4 parts per million. In some embodiments, the threshold limit may be set by the treatment plant in which the methods described herein are employed.

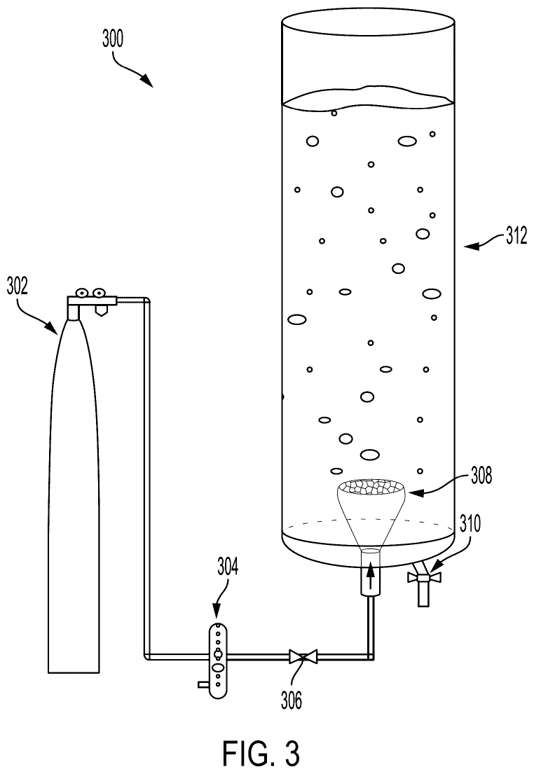

FIG. 3 is an example diagram of a bubble tower reactor for treating gas collected and directed through the tower according to one example of the present disclosure. One skilled in the art may understand that while a bubble tower depicted in FIG. 3 may be used for removing a gas from a mixture of gases, it is employed here merely as an example and should not limit the scope of the present disclosure. Other reactor types may be used for removing H₂S from a gas mixture. A bubble tower reactor system may include at least a flow meter 304, a control valve 306, a tank 312, a sparger 308, and an exit valve 310. In some embodiments, the system may include alternate components or configurations that may be used for further improving the efficiency of removal. In some embodiments, the flow meter 304 may be positioned in liquid communication with the pipeline flowing from the gas collection reservoir 302 to the control valve 304. In some embodiments, the gas collection reservoir 302 may be a gas cylinder, a direct injection line from gas collected during the wellbore operations, or a flowline from a gas source that has been initially recycled. The gas collection reservoir may be attached to pumps that may aid in pumping the gas from the collection reservoir to the tank/tower.

The control valve 306 may be used for changing the flow rate of gas from the gas collection reservoir 312 through the sparger 308 and into the tank 312. For example, the flow rate of gas may be varied depending on the concentration of the compound to be scavenged from the gas. For example, a higher concentration of H₂S in the gas may require a slower flow rate without altering the chemical composition of the solution in the tank 312. In some embodiments, the concentration of solution in the tank may be altered in combination with the flow rate of gas into the tank. For example, the flow rate of gas may be from 1 liter per minute to 1000 liters per minute through the sparger and into the tank. In some embodiments, the concentration of H₂S may first be measured to determine the optimal flow rate into the system. In some embodiments, the flow rate of gas through the system may be varied following a measure of H₂S in treated gas. For example, using methods described herein, if the concentration of H₂S is deemed high or outside of the range for safe disposal, the flow rate may be adjusted upstream to ensure proper removal of H₂S is occurring.

In some embodiments, the tank 306 may be preselected based on factors of the operation. For example, factors affecting the size of the tank used in the bubble tower may include physical and chemical properties of the subterranean formation, chemical properties of the gas extracted, expected efficiency of scavenging process, and budget of the operators of the oil field. The size of the tank may be selected based upon a quantity of liquid it is capable of holding from 100 gallons to 2000 gallons. In some embodiments, the pressure inside of the tank 306 may be controlled. For example, the pressure inside the tank 306 may be from 3 MPa to 20 MPa. By controlling the pressure inside the bubble tower reactor, the quality and stability of the bubbles generated may be controlled, allowing for increased contact time with the scavenging material and reducing the chance for foaming or coalescing of the bubbles.

In some embodiments, the scavenging material used to remove H₂S from the water phase may be categorized into three groups. For example, water-soluble scavengers, oil-soluble scavengers, and metal-based scavengers. Water-soluble scavenging material may be the most common product of choice for applications at temperatures below 200° F. (93° C.). Such water-soluble scavengers may include triazine. In some embodiments, oil-soluble scavengers may be used in high temperature applications or when water tolerance of the hydrocarbon is an issue. For example, oil-soluble scavengers may be amine-based compounds such as alkylamine formaldehyde condensate. In some embodiments, the metal-based scavenger may be used in embodiments where a specific need of very-high temperature and high-H₂S concentration applications. For example, for treatment of asphalt.

Triazine compounds may have added benefits because they can be modified to become more or less hydrophilic by using different side groups on the nitrogen atoms. In some embodiments, a hydroxyethyl-side group may be used. In an alternate embodiment, the triazine may be substituted with purely non-polar side groups. For example, shown below are structures of triazine compounds, 1,2,3 triazine, 1,2,4 triazine, and 1,3,5 triazine. The R groups may be independently selected from hydrogen, nitrogen, chlorine, bromine, alcohol, methyl, alkyl groups, aryl groups, or an amino group.

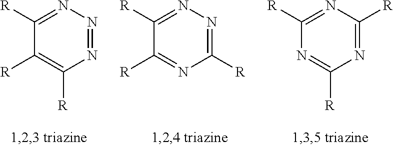

In some embodiments, the concentration of the scavenging material may be increased or decreased based on the concentration of H₂S in the gas. For example, triazine, when unreacted, is toxic while byproducts, such as dithiazine, are non-toxic and can be further treated out of solution. When the concentration of triazine is too much in excess of the H₂S gas, unreacted triazine may be left in solution, thus the appropriate concentration of triazine must be selected such that after scavenging, there is minimal to no unreacted triazine. For example, the concentration of triazine may be from 10 gram per liter (g/L) to 200 g/L in the total solution. In some embodiments, the ratio of scavenging material to H₂S is from 1:1 to 4:1. In some embodiments, the scavenging material is in excess of H₂S by at least 25% when compared to the removal capacity of the H₂S scavenging material for the H₂S in the gaseous mixture or the reduced amount or concentration of H₂S in the cleaned gaseous mixture corresponds to removal of 99% or more of the H₂S from the gaseous mixture. In some embodiment, other chemical additives may be added to liquid. For example, buffers may be added to solution. By controlling the concentration of triazine such that the reaction efficiency is at or near 100% and there is minimal unreacted triazine, the cost may be significantly reduced. In some embodiments, alternate scavenging materials may be used. For example, the methods described herein may be employed with alternate H₂S scavenging materials in solution.

Other bubble tower configurations may be used for scavenging from water. It may be understood by those skilled in the art that any configurations disclosed herein are provided as examples and that modifications may be made to the bubble tower reactor, as shown for example, to further improve efficiency removal. In some embodiments, the bubble reactor system employed may have an inlet valve located at the top of the tower for injecting liquid into the bubble tower. The inlet positioned at the top of the tower may have a control valve for increasing or decreasing the flow of liquid into the tower. For example, the flow of water into the tower from above may be from 1 gallon per minute (GPM) to 100 GPM. In some embodiments, the flow of water into the tower may be varied in parallel with the gas inlet flow such that the pressure of water flowing into the tower collides with the bubbles rising through the tower and the collision of the two pressures cause the bubbles to decrease in rising speed or come to a halt thereby increasing contact time within the solution. In an alternate embodiment, the gas may rise to the surface of the tower whereby an outlet valve may be located. The outlet valve may allow for gas to flow into the base of a second bubble tower reactor whereby the gas may react a second time in a new solution to further remove H₂S. Alternate configurations may be employed. For example, the scavenging system may include a contact tower connected to a separator tower, the separator tower may be in fluid communication with a tank for collecting spent chemical liquid. The contact tower may be in fluid communication with a second tank for holding fresh or clean chemical solution. Pumps may be in line connected between the fresh tank inlet and the contact tower. The contact tower may include the sparger, such as the nano-bubbler. In some cases, fluids (liquids and gases) may be recirculated back into the contact tower after for repeated scavenging, if desired.

In some embodiments, the sparger 308 may be selected such that the sparger is a nano-bubbler. A nano-bubbler may be known as a sparger system that produced nano-bubbles. For example, the nanobubbles produced from a nano-bubbler may be from 1 nm to 1000 nm in diameter. The nano-bubbles may increase surface area of the H₂S gas for contact with the scavenging material. For example, nano materials may have a much larger surface-to-volume ratio when compared to other macro materials (e.g., materials, having a diameter greater than 1 μm). By injecting nano bubbles into the system, the surface area of bubble to solution may be increased. In some embodiments, the sparger 208 that is the nano-bubbler may be controlled to change the size of the nano bubbles. The nano bubble may be a homogenous size, or within ±10 nm of one another. For example, the nano bubbles may be from 10 nm to 20 nm, from 20 nm to 30 nm, from 30 nm to 40 nm, from 40 nm to 50 nm, from 50 nm to 60 nm, from 60 nm to 70 nm, from 70 nm to 80 nm, from 80 nm to 90 nm, from 90 no to 100 nm, up to 1000 nm in 10 nm increments. The sparger may be used to direct the nanobubbles in a travel direction counter to a flow direction of the liquid. The flow rate of the gas through the sparger and of the liquid may be controllable to adjust the retention time of the nanobubbles in the liquid.

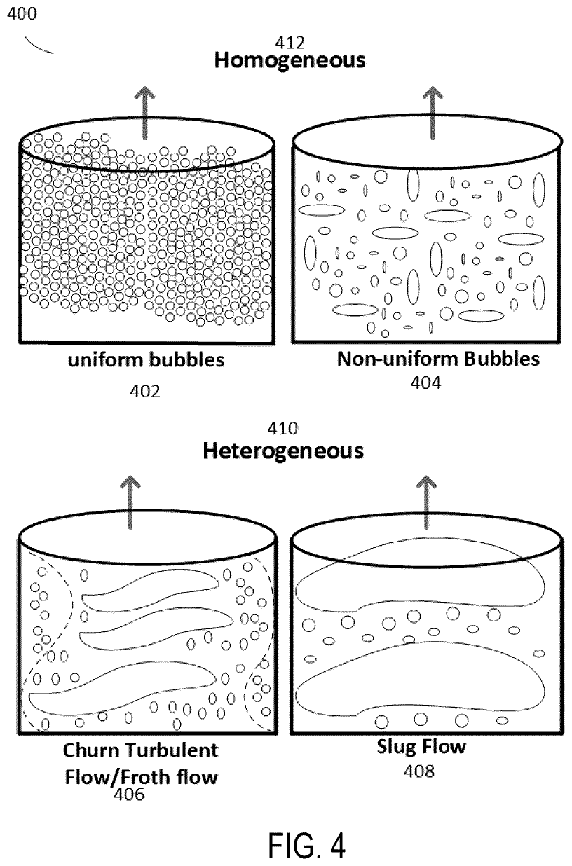

FIG. 4 provides example schematics of the bubbles produced in a bubble tower reactor according to one or more examples of the present disclosure. Common bubble tower reactors may produce bubbles that may be non-uniform or inconsistent (see non-uniform bubbles 404). For example, the bubbles may be heterogeneous. Heterogeneous bubbles 410 may cause imperfect or bad bubbles. The imperfect bubble creation may reduce efficiency of scavenging. In some embodiments, the heterogeneous bubbles may cause churn turbulent 406. Churn turbulent may refer to a two-phase gas/liquid flow regime characterized by a highly-agitated flow where gas bubbles may be sufficient in numbers to both interact with each other and, while interacting, coalesce to form larger distorted bubbles with unique shapes and behaviors in the system. Churn turbulent flow may be created when there is a large gas fraction in a system with a high gas and low liquid velocity. In bubble towers, churn turbulent may be insufficient for removal of H₂S gas. In some embodiments, the heterogeneous flow of gas created by the sparger may be a slug flow 408. Slug flow may refer to a gas flow in a bubble tower that causes large pockets of gas bubbles to separate large pockets of liquid, thus creating less surface area of contact between the liquid including the scavenging material and the H₂S gas. In some embodiments, the sparger described above and in FIG. 3 may be used to create a more uniform flow of gas bubbles in the bubble tower reactor. In some embodiments, the nano-bubbler may create a flow of bubbles that do not generate a foam in the solution, providing a clean and efficient source of bubbles in the bubble tower reactor. Common bubble towers may produce homogenous bubbles 412. In such an event homogenous bubbles 412 is used to refer to a bubble tower reactor that may produce bubbles in a consistent manner. However, the homogenous bubbles 412 system may include non-uniform bubbles 404. In this environment, while the tower is consistently producing bubbles, the bubbles produced may be non-uniform 404 in size and shape where some are larger than others, or others are produced as ovular shapes instead of circular. This non-uniformity may impact scavenging efficiency by reducing the surface area of the bubbles within the liquid.

The sparger 308, in FIG. 3, may be a nano-bubbler for producing bubbles that may be referred to as uniform bubbles 402 according to examples of the present disclosure. Uniform bubbles may be used to describe the homogeneous production of bubbles in the bubble tower. The homogeneous bubbles 412 may be nanoparticle sized. For example, the bubbles produced in the nano bubbler may be from 1 nm to 1000 nm as described above. The uniform bubbles 402 produced may provide an environment for the highest efficiency of scavenging due to the higher surface area in total across all the bubbles produced. Additionally, the uniform production of bubbles may not create pockets of larger bubbles resulting in scavenging loss and H₂S making it through the system The gas collected from the wellbore or subterranean formation may be further injected with a carrier gas for transporting, through the pipelines, the sour gas. In some embodiments, the carrier gas may be a natural gas, for example, methane. In an alternate embodiment, the carrier gas may be a gas supply that is non-reactive with the presence of oxidizers. In some embodiments, the non-reactive gases may include argon, carbon dioxide, helium, and nitrogen gas. The non-reactive gas may be injected into the subterranean formation or wellbore to aid in removal of the trapped sour gas underground and transport the gas mixture to the holding tank or directly to the bubble tower reactor. I

In some aspects, materials, methods, and systems for improving scavenging efficiency of H₂S in reactors used in wellbore operations are provided according to one or more of the following examples. As used below, any reference to a series of examples is to be understood as a reference to each of those examples disjunctively (e.g., “Examples 1-4” is to be understood as “Examples 1, 2, 3, or 4”).

Example 1 is a method for scavenging hydrogen sulfide generated during wellbore or hydrocarbon production operations, the method comprising: collecting a gaseous mixture generated during a wellbore operation or hydrocarbon production operation, wherein the gaseous mixture comprises H₂S; injecting the gaseous mixture into a liquid as a plurality of nanobubbles, wherein the liquid comprises a H₂S scavenging material that interacts with the nanobubbles and removes H₂S from the nanobubbles; and outputting a cleaned gaseous mixture containing a reduced amount or concentration of H₂S compared to the gaseous mixture.

Example 2 is the method of example 1, wherein the nanobubbles are of a controlled size ranging from 1 nm to 1000 nm in diameter.

Example 3 is the method of any one of examples 1-2, wherein injecting the gaseous mixture is performed at flow rate of from 1 to 5000 gallons per minute, and wherein injecting the gaseous mixture into the liquid occurs as a batch operation or a continuous operation.

Example 4 is the method of any one of examples 1-3, wherein the gaseous mixture is injected into the liquid in combination with a carrier liquid or a carrier gas and wherein the gaseous mixture is injected into a bubble tower reactor.

Example 5 is the method of any one of examples 1-4, wherein the carrier liquid is water, brine, or oil.

Example 6 is the method of example 4, wherein the carrier gas is methane or an inert gas.

Example 7 is the method of any one of examples 1-6, wherein the H₂S scavenging material comprises a triazine, and wherein a concentration of the triazine in the liquid is between 1 ppm and 10000 ppm.

Example 8 is the method of any one of examples 1-7, wherein injecting the gaseous mixture into the liquid occurs as a batch operation or a continuous operation.

Example 9 is the method of any one of examples 1-8, wherein a concentration of the H₂S scavenging material in the liquid is in excess by at least 25% as compared to a removal capacity of the H₂S scavenging material for the H₂S in the gaseous mixture, or wherein the reduced amount or concentration of H₂S in the cleaned gaseous mixture corresponds to removal of 99% more of the H₂S from the gaseous mixture.

Example 10 is the method of any one of examples 1-9, further comprising analyzing the cleaned gaseous mixture and modifying a composition or condition of the liquid or gaseous mixture to adjust an amount or concentration of H₂S in the cleaned gaseous mixture.

Example 11 is the method of example 10, wherein modifying the composition or condition comprises one or more of: adjusting a temperature of the liquid or the gaseous mixture; or adjusting a pressure of the liquid or the gaseous mixture; or adjusting an amount or concentration of the H₂S scavenging material in the liquid; or adjusting a flow rate of the liquid or the gaseous mixture.

Example 12 is a system comprising: a fluid containment or flow system at least partially filled with a liquid comprising a H₂S scavenging material; an inlet coupled to a sparger within the fluid containment for injecting a gaseous mixture comprising H₂S into the liquid as a plurality of nanobubbles, wherein the H₂S scavenging material is configured to interact with the nanobubbles to remove H₂S from the nanobubbles and generate a cleaned gaseous mixture containing a reduced amount of H₂S compared to the gaseous mixture; at least one outlet within the fluid containment for removing the cleaned gaseous mixture.

Example 13 is the system of example 12, wherein the sparger is configured for controllably producing nanobubbles ranging from 1 nm to 1000 nm in diameter.

Example 14 is the system of any one of examples 12-13, further comprising one or more sensors for monitoring a first characteristic of the liquid or the gaseous mixture and one or more controllers for controlling a second characteristic of the liquid or the gaseous mixture, wherein characteristics of the liquid or gaseous mixture include one or more of a temperature, a pressure, a flow rate, a concentration of a salt, a concentration of H₂S, a concentration of the H₂S scavenging material, a concentration of a contaminant, or a concentration of a reaction product for reaction between H₂S and the H₂S scavenging material.

Example 15 is the system of any one of examples 12-14, wherein the gas mixture is generated during a wellbore operation or hydrocarbon production operation.

Example 16 is the system of any one of examples 12-15, wherein the H₂S scavenging material comprises a triazine, and wherein a concentration of the triazine in the liquid is between 1 ppm and 10000 ppm.

Example 17 is the system of any one of examples 12-16, wherein the fluid containment comprises a bubble tower, and wherein the sparger is arranged to direct the nanobubbles in a travel direction counter to a flow direction of the liquid and wherein flow rates of the liquid and the gaseous mixture in the fluid containment are controllable to adjust a retention time of the nanobubbles in the liquid.

Example 18 is the system of any one of examples 12-17, wherein a concentration of the H₂S scavenging material in the liquid is in excess by at least 25% as compared to a removal capacity of the H₂S scavenging material for the H₂S in the gaseous mixture.

Example 19 is the system of any one of examples 12-18-,

Example 20 is the system of any one of examples 12-19, wherein the CO₂ concentration is reduced in the gaseous mixture by at least 5% by volume to by at least 25% by volume, or greater.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A method for scavenging hydrogen sulfide generated during wellbore or hydrocarbon production operations, the method comprising:
collecting a gaseous mixture generated during a wellbore operation or hydrocarbon production operation, wherein the gaseous mixture comprises H₂S;
injecting the gaseous mixture into a liquid as a plurality of nanobubbles, wherein the liquid comprises a H₂S scavenging material that interacts with the nanobubbles and removes H₂S from the nanobubbles; and
outputting a cleaned gaseous mixture containing a reduced amount or concentration of H₂S compared to the gaseous mixture.

2. The method of claim 1, wherein the nanobubbles are of a controlled size ranging from 1 nm to 1000 nm in diameter.

3. The method of claim 1, wherein injecting the gaseous mixture is performed at flow rate of from 1 to 5000 gallons per minute, and wherein injecting the gaseous mixture into the liquid occurs as a batch operation or a continuous operation.

4. The method of claim 1, wherein the gaseous mixture is injected into the liquid in combination with a carrier liquid or a carrier gas and wherein the gaseous mixture is injected into a bubble tower reactor.

5. The method of claim 4, wherein the carrier liquid is water, brine, or oil.

6. The method of claim 4, wherein the carrier gas is methane or an inert gas.

7. The method of claim 1, wherein the H₂S scavenging material comprises a triazine, and wherein a concentration of the triazine in the liquid is between 1 ppm and 10000 ppm.

8. The method of claim 1, wherein injecting the gaseous mixture into the liquid occurs as a batch operation or a continuous operation.

9. The method of claim 1, wherein a concentration of the H₂S scavenging material in the liquid is in excess by at least 25% as compared to a removal capacity of the H₂S scavenging material for the H₂S in the gaseous mixture, or wherein the reduced amount or concentration of H₂S in the cleaned gaseous mixture corresponds to removal of 99% more of the H₂S from the gaseous mixture.

10. The method of claim 1, further comprising analyzing the cleaned gaseous mixture and modifying a composition or condition of the liquid or gaseous mixture to adjust an amount or concentration of H₂S in the cleaned gaseous mixture.

11. The method of claim 10, wherein modifying the composition or condition comprises one or more of:
adjusting a temperature of the liquid or the gaseous mixture; or
adjusting a pressure of the liquid or the gaseous mixture; or
adjusting an amount or concentration of the H₂S scavenging material in the liquid; or
adjusting a flow rate of the liquid or the gaseous mixture.

12. A system for scavenging hydrogen sulfide generated during wellbore or hydrocarbon production operations comprising:
a fluid containment at least partially filled with a liquid comprising a H₂S scavenging material;
an inlet coupled to a sparger within the fluid containment for injecting a gaseous mixture comprising H₂S into the liquid as a plurality of nanobubbles, wherein the H₂S scavenging material is configured to interact with the nanobubbles to remove H₂S from the nanobubbles and generate a cleaned gaseous mixture containing a reduced amount of H₂S compared to the gaseous mixture;
at least one outlet within the fluid containment for removing the cleaned gaseous mixture.

13. The system of claim 12, wherein the sparger is configured for controllably producing nanobubbles ranging from 1 nm to 1000 nm in diameter.

14. The system of claim 12, further comprising one or more sensors for monitoring a first characteristic of the liquid or the gaseous mixture and one or more controllers for controlling a second characteristic of the liquid or the gaseous mixture, wherein characteristics of the liquid or gaseous mixture include one or more of a temperature, a pressure, a flow rate, a concentration of a salt, a concentration of H₂S, a concentration of the H₂S scavenging material, a concentration of a contaminant, or a concentration of a reaction product for reaction between H₂S and the H₂S scavenging material.

15. The system of claim 12, wherein the gaseous mixture is generated during a wellbore operation or hydrocarbon production operation.

16. The system of claim 12, wherein the H₂S scavenging material comprises a triazine, and wherein a concentration of the triazine in the liquid is between 1 ppm and 10000 ppm.

17. The system of claim 12, wherein the fluid containment comprises a bubble tower, and wherein the sparger is arranged to direct the nanobubbles in a travel direction counter to a flow direction of the liquid and wherein flow rates of the liquid and the gaseous mixture in the fluid containment are controllable to adjust a retention time of the nanobubbles in the liquid.

18. The system of claim 12, wherein a concentration of the H₂S scavenging material in the liquid is in excess by at least 25% as compared to a removal capacity of the H₂S scavenging material for the H₂S in the gaseous mixture.

19. The system of claim 12, wherein the system further comprises an injection port for injecting a scavenging material or carrier gas into the gaseous mixture, wherein the scavenging material at least partially removes CO₂ gas from the gaseous mixture prior to injection into the bubble tower.

20. The system of claim 19, wherein the CO₂ concentration is reduced in the gaseous mixture by at least 5% by volume to by at least 25% by volume, or greater.
